(19) United States
(12) Patent Application Publication
(10) Pub. No.: US 2018/0333667 A1
(43) Pub. Date: Nov. 22, 2018

(54) SYSTEM AND METHOD FOR MONITORING CONDITION OF CABIN AIR FILTER

(71) Applicant: Ford Global Technologies, LLC, Dearborn, MI (US)

(72) Inventors: Clay Wesley MARANVILLE, Ypsilanti, MI (US); Manfred KOBERSTEIN, Troy, MI (US); Jennifer A. HERR-RATHKE, Plymouth, MI (US)

(21) Appl. No.: 15/598,567

(22) Filed: May 18, 2017

(51) Int. Cl. B01D 46/00; B01D 46/46; B01D 46/52

(52) U.S. Cl. CPC B01D 46/0086; B01D 46/0045; B01D 2273/30; B01D 46/521; B01D 46/46

(57) ABSTRACT

A climate control system includes a cabin air filter and a blower assembly having a motor and a fan rotated by the motor. The fan is configured to circulate air through the cabin air filter when the motor is energized. A controller is programmed to issue a message to change the cabin air filter in response to a revolution count of the motor exceeding a predefined threshold.

### TECHNICAL FIELD

This disclosure relates to a control system and method for monitoring the condition of a cabin air filter and for issuing a message to the driver to change the cabin air filter.

### BACKGROUND

Vehicles typically include climate control systems for managing the temperature and humidity of a passenger cabin. The climate control system may include a heating, ventilation, and air conditioning (HVAC) housing disposed behind a dashboard of the passenger cabin. A blower motor powers a fan disposed in the HVAC housing. The fan draws ambient air from outside the vehicle (or recirculated air) and circulates the air through the HVAC housing and into the passenger cabin. The ambient air may pass through an air filter prior to entering the cabin to remove dust and other unwanted particles.

### SUMMARY

According to one embodiment, a climate control system includes a cabin air filter and a blower assembly having a motor and a fan rotated by the motor. The fan is configured to circulate air through the cabin air filter when the motor is energized. A controller is programmed to issue a message to change the cabin air filter in response to a revolution count of the motor exceeding a predefined threshold.

According to another embodiment, a climate control system includes a fluid path, a blower motor, and a fan fixed to a spindle of the blower motor and disposed in the path. An air filter is also disposed in the path. A controller is programmed to, in response to a revolution count of the motor exceeding a predefined threshold, issue a message to change the air filter.

According to yet another embodiment, a method of monitoring a cabin air filter of a climate system is performed by a controller. The method includes operating a blower motor that drives a fan configured to circulate an airstream through the cabin air filter. The method further includes issuing a message to change the cabin air filter in response to counted revolutions of the blower motor exceeding a predefined threshold.

### BRIEF DESCRIPTION OF THE DRAWINGS

FIG. 1 is a cross-sectional view of a portion of an HVAC unit and surrounding environment.

FIG. 2 is a schematic cross-sectional view of a blower assembly of the HVAC unit.

FIG. 3 is control system diagram.

FIG. 4 is a flow chart of an algorithm for monitoring a cabin air filter of a climate controller system according to one embodiment.

FIG. 5 is a flow chart of an algorithm for monitoring a cabin air filter of a climate control system according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

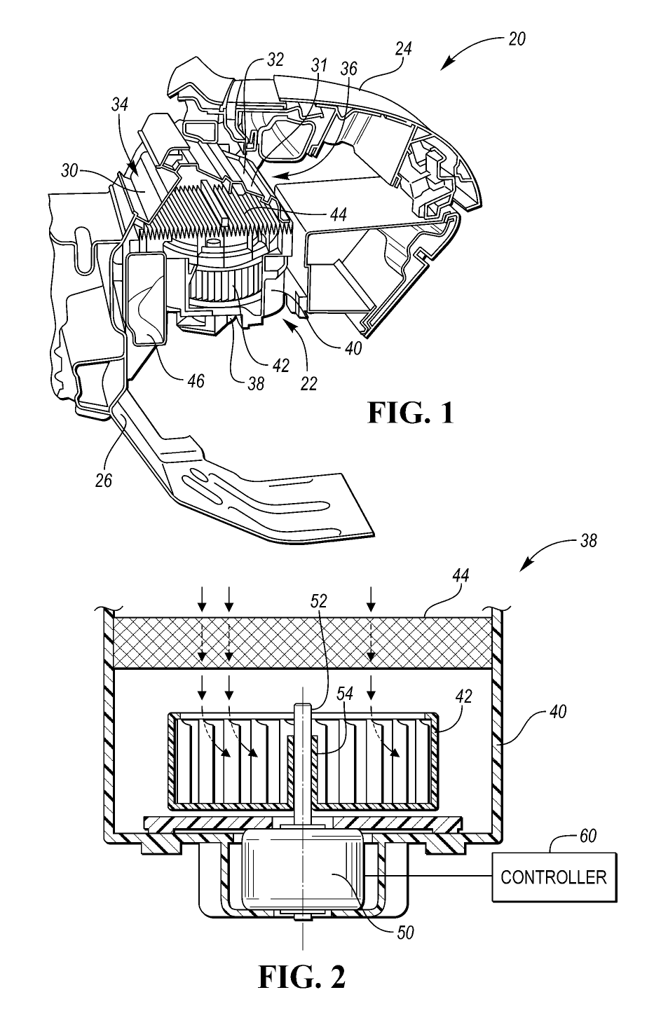

A vehicle, such as a passenger car, includes a climate control system 20 for conditioning air, e.g., heating and cooling, of a passenger cabin. The climate control system 20 includes an HVAC unit 22 located behind the dashboard 24 and rearward of a bulkhead 26 that separates the engine compartment from the passenger compartment. The HVAC unit 22 includes a plurality of housings and assemblies that are interconnected with each other, only a select portion of which, is illustrated in FIG. 1.

The HVAC unit 22 may include an upper housing 32 that defines a fresh air inlet 34 and a recirculated air inlet 36. The fresh air inlet 34 may be connected to one or more ducts (not shown) that extends to an exterior portion of the vehicle, such as below the cowl at the base of the windshield, to route outside air to the inlet 34. One or more other ducts (not shown) may route air from the passenger cabin to the recirculated air inlet 36. The upper housing 32 may include doors 30 and 31 that selectively open and close the fresh air inlet 34 and the recirculated air inlet 36.

A blower assembly 38, of the HVAC unit 22, is located below the upper housing 32 and is in fluid communication with the fresh air inlet 34 and the recirculated air inlet 36. The blower assembly 38 may include a blower housing 40 that is connected to the upper housing 32 by fasteners, clips, adhesive, or the like. A blower motor (not shown) and a blower fan 42 are disposed in the blower housing 40. The fan 42 is fixed to a spindle of the blower motor and rotates with the spindle when the motor is energized. The fan 42 may be a scroll fan that draws air into a center of the fan 42 and forces the air radially outward when spinning. The blower housing 40 defines an outlet duct 46 that routes air from the fan 42 to another portion of the HVAC unit 22.

The climate control system 20 includes a cabin air filter 44 that removes debris, dust, pollen, and other unwanted elements from the airstream prior to entering the passenger cabin. In the illustrated embodiment, the cabin air filter is disposed in the HVAC unit 22 between the upper housing 32 and the blower assembly 38. In other embodiments, the cabin air filter 44 may be located upstream of the HVAC unit 22, such as in the air duct below the cowl, downstream of the fan 42, or in another location. When energized, the fan 42 draws an airstream through a fluid path that starts at an exterior inlet, extends through a series of ducts and the HVAC unit 22, and ends at the passenger cabin outlet vents. The cabin air filter 44 is disposed in the path to condition the airstream prior to entering the passenger cabin.

FIG. 2 illustrates a schematic cross-sectional view of the blower assembly 38. The blower assembly 38 includes an electric motor 50 that is mounted to the housing 40. The motor 50 may be disposed within the housing 40 as shown, or may be mounted outside of the housing. The motor 50 may include a stator (not shown) and a rotor (not shown) supported for rotation within the stator. A spindle 52 (also known as a driveshaft) may be fixed to the rotor and extend outwardly from the motor housing. The fan 42 includes a hub 54 that is received on the spindle 52 in such a way that the hub 54 and the spindle 52 are rotationally fixed.

The vehicle includes a vehicle controller 60. While illustrated as one controller, the controller 60 may be part of a larger control system and may be controlled by various other controllers throughout the vehicle. Any referred to a “controller” means one or more controllers. The controller 60 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine, traction battery, transmission, or other vehicle systems.

The controller communicates with various sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. The various components of the control system may communication over a CAN bus or via dedicated wires.

The vehicle controller 60 may control operation of the climate control system 20 including the speed of the fan, the temperature of the airstream, the mode (heat, air conditioning, etc.) and many others. The speed of the fan may be controlled by varying the voltage commanded to the blower motor by the controller 60. For example, the fan speed may increase proportionally to voltage increase, and may decrease proportionally to voltage decrease. Thus, the voltage commanded to the fan 42 may be highest when the driver desires fan to be on HIGH, and lowest when the customer desires the fan 42 to be on LOW.

When the driver desires the climate control system 20 to be ON, voltage and current are commanded to the electric motor 50, by the controller 60, causing the fan 42 to rotate. Rotation of the fan 42 draws an airstream through the air filter 44 and subsequently into the passenger cabin.

Over time, contaminants in the airstream accumulate in the air filter 44 necessitating replacement of the filter. Car manufacture may provide a maintenance schedule that suggests when to change the air filter. The time period between installation and recommended replacement of the air filter may be referred to herein as the “life” of the air filter or “air filter life.” Traditionally, the maintenance schedule is located in the owner's manual for the vehicle. While many owners are aware of certain maintenance items, such as oil changes, many owners are not aware of the cabin air filter and when it should be changed. Consequently, many owners fail to ever change the cabin air filter, which leads to not only decrease performance of the filter itself, but also of the climate control system due to suction losses associated with the reduced porosity of a dirty filter.

The following figures and textual description describe example control strategies and methods for monitoring life of the cabin air filter and for suggesting a filter changer to the driver. Rather than simply monitoring filter life based on age of the filter or vehicle mileage, the control system and method of this disclosure may also monitor filter life based on usage of the blower motor. The blower motor drives the fan, which is the component that draws the airstream through the filter, and thus is a good indicator for estimating the amount of air that has passed through the filter. In one embodiment, the life of the filter may be based on a count of the revolutions of the blower motor. The controller may count the revolutions of the blower motor and issue a “change filter” message to the driver in response to the count exceeding a threshold value. This will be described in more detail below with reference to the flow charts and associated text.

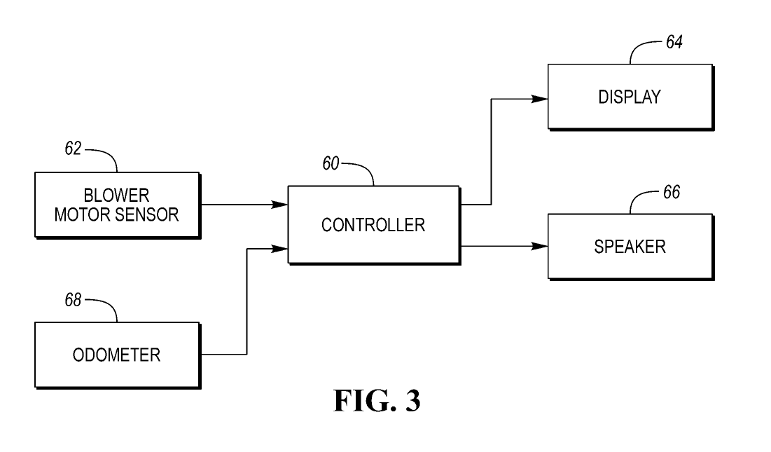

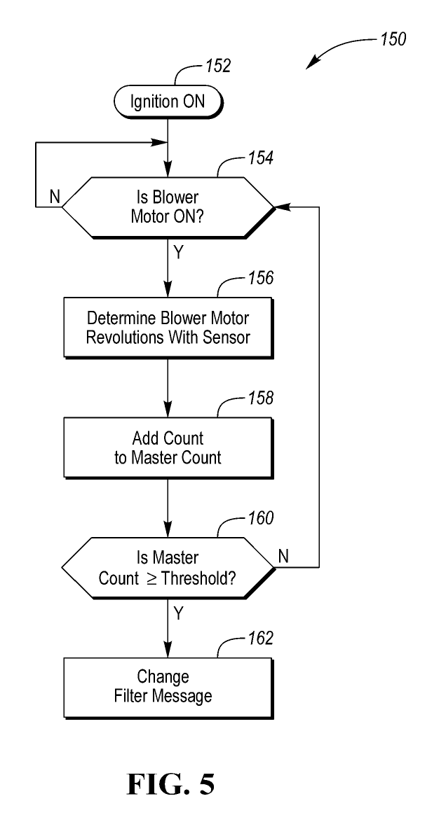

Referring to FIG. 3, in one embodiment, the revolutions of the motor 50 may be based on signals from a sensor 62. The sensor 62 may measure speed, or rotations in other embodiments, of the blower motor 50 (e.g., the spindle or the rotor), the fan 42, or other object. Many types of sensors are known for measuring speeds of a rotating object. In one embodiment, the sensor may be a hall-effect sensor. The sensor 62 is configured to send a signal to the controller 60 indicative of the speed (revolutions per second) of the object being measured. The controller 60 includes logic for converting these speeds into a count and tallying these counts as a “master count” saved in non-volatile memory. The master count is the total number of motor revolutions that have occurred while the current filter is installed on the vehicle. The controller 60 further includes logic for comparing the master count to a threshold count, and, in response to the master count exceeding the threshold count, issuing a message to the driver instructing the air filter 44 to be changed. This message may be sent to a display 64 and/or to a speaker 66 for presentation to the driver. The controller 60 may also be programmed to issue a change filter message in response to filter mileage exceeding a predefined threshold. The vehicle odometer 68 may be used to determine the filter mileage. Used herein, filter mileage refers to the number of miles the vehicle has traveled while the filter was installed on the vehicle. This embodiment will be described in more detail below with reference to the flow chart of FIG. 5.

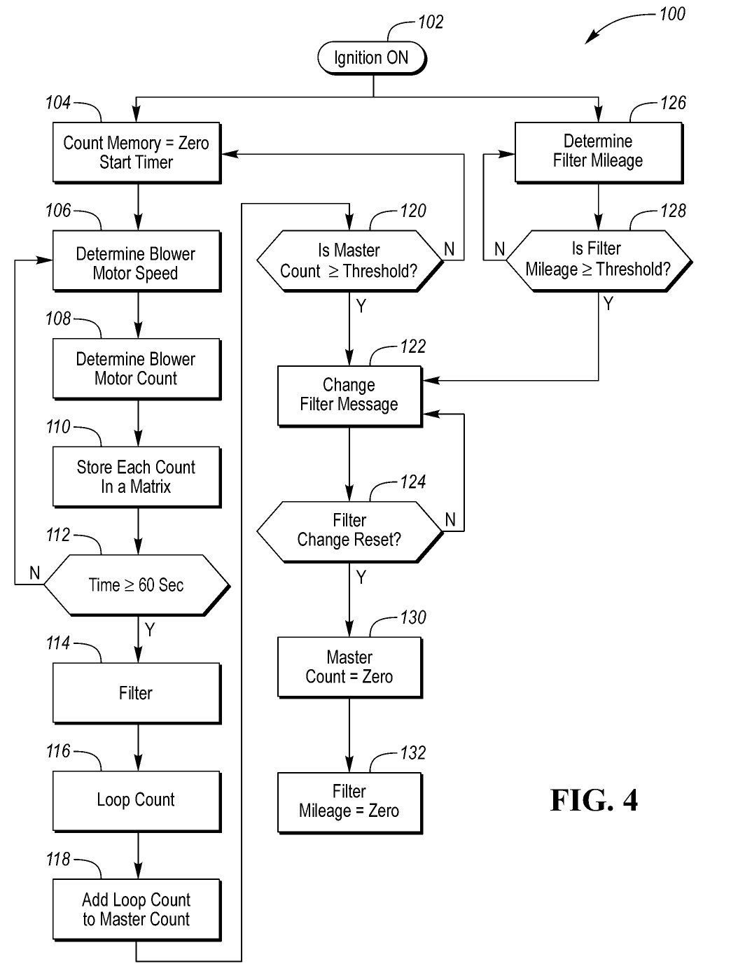

In another embodiment, the revolutions of the motor 50 are inferred rather than being directly measured by a sensor. This has the advantage of eliminating the sensor. As explained above, the speed of the motor 50 is dependent upon the voltage commanded to the motor by the controller 60. Thus, motor speed can be inferred from the commanded voltage. The controller 60 may include one or more look up tables that correlate commanded voltage to motor speed. The motor speed may have units of revolutions per time, e.g., revolutions per second. This allows the number of revolutions to be quickly calculated for any given time period. This embodiment will be described below in more detail with reference to the flow chart of FIG. 4.

Control logic or functions performed by controller 60, or other controller, may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 60. Of course, the control logic may be implemented in software, hardware, or a combination of software and hardware in one or more controllers depending upon the particular application. When implemented in software, the control logic may be provided in one or more computer-readable stowed devices or media having stored data representing code or instructions executed by a computer to control the vehicle or its subsystems. The computer-readable stowed devices or media may include one or more of a number of known physical devices which utilize electric, magnetic, and/or optical stowed to keep executable instructions and associated calibration information, operating variables, and the like.

Referring to FIG. 4, a flow chart 100 of an algorithm for monitoring a cabin air filter of a climate controller system begins at operation 102 when the ignition of the vehicle is turned ON. To facilitate counting of the blower fan revolutions, the count may be broken down into multiple counts including a master count, which is the total number of revolutions of the blower fan saved in non-volatile memory, and a loop count that is the number of revolution of the blower fan within a predetermined time, such as 60 seconds. Once the timer for the loop expires, a final loop count is tallied and added to the master count. Thus, the master count, in this embodiment, is comprised of a plurality of loop counts that have been added together.

Each loop begins at operation 104 where the loop count is set to zero and the timer is started. The loop begins when the is timer started and ends when the timer has reached the predetermined time period. In the illustrated embodiment, each loop is 60 seconds long and the processor speed is set so that operations 104 to 110 are completed on one second intervals. The time and processor speeds may be different in other embodiments.

At operation 106, the controller determines the blower motor speed by determining the currently commanded voltage to the motor and calculating a correlated blower motor speed using the lookup tables. The blower motor speed has units of revolutions per second (RPS). Since each loop iteration is 1 second long, the motor count for that iteration is the motor speed with the time term is removed. The controller converts motor speed to motor count at operation 108. To illustrate the point, if the motor speed at operation 106 is 100 RPS, then the blower count at operation 108 is 100 revolutions.

The motor-revolution count for each iteration is saved in a matrix at operation 110. The matrix is a listing of counts for each iteration of the current loop. At operation 110, the controller determines if the timer is greater than or equal to 60 seconds. If no, control goes back to operation 106 and the current loop continues. If yes, the loop has ended and control passes to operation 114 where the matrix is filtered to remove counts that are flagged as erroneous. Counts may be flagged as erroneous if their magnitude is larger than the magnitude of adjacent counts by a predetermined amount. Other factors may also be used. The filtering step of operation 114 is optional.

Once filtering is complete, a final loop count is compiled at operation 116. The loop count of operation 116 is added to the master count at operation 118. Control then passes to operation 120 where the master count is compared to a threshold count to determine if the filter life has expired. If no at operation 120, control loops back to operation 104 and a new loop is begun. If yes at operation 120, control passes to operation 122 and the controller issues a change filter message to the driver. The message may be a visual message that is displayed on the instrument panel or other display, or may be in auditory alert that is played through the speakers.

The life of the filter may also be determined based on filter mileage. For example, the change filter message may be issued in response to the master count being exceeded or the filter mileage exceeding a threshold mileage. The change filter message is issued based on whichever of these events occurs first. Control operations 126 through 128 may occur in parallel with control operations 104 through 120. At operation 126, the controller determines the filter mileage. This may be based on readings from the odometer. For example, the controller may include control logic that adds 1 mile to the filter mileage every time the vehicle travels a mile. At operation 128, the controller compares the filter mileage to a threshold, and if the threshold is exceeded, control passes to operation 122 and the change filter message is issued. If no at operation 128, control loops back to operation 126.

The driver is able to reset the master count after the filter has been changed to remove the change filter message. This may be done via a user interface. At operation 124, the controller determines if the driver has request reset of the master count. If no, the change filter message continues to be presented. If yes, control passes to operation 130 and the master count is set to zero, and control passes to operation 132 and the filter mileage is also set to zero.

FIG. 5 illustrates another flow chart 150 of an algorithm for counting revolutions of the blower motor. In this embodiment, the revolutions are based on signals from a sensor that measures speed or rotations of the motor. The control strategy begins at operation 152 when the ignition is turned ON. At operation 154 the controller determines if the blower motor is ON. If no, control loops until the blower motor is turned ON. If yes, control passes to operation 156 and the controller determines the blower-motor revolutions based on signals from the sensor. The sensor may output a signal indicative of a measured speed of the motor. The controller converts the motor speed into counts, tallies these counts, and adds them to a master count at operation 158. At operation 160, the controller determines if the master count is greater than or equal to a threshold, and if yes, a change filter message is issued at operation 162 to alert the driver to change the filter. If no at operation 160, control loops back to operation 154. While not illustrated in the figure, the master count may be reset once the filter is changed according to the above teachings.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A climate control system comprising:
a cabin air filter;
a blower assembly including a motor and a fan rotated by the motor, wherein the fan is configured to circulate air through the cabin air filter when the motor is energized; and
a controller programmed to issue a message to change the cabin air filter in response to a revolution count of the motor exceeding a predefined threshold.

2. The climate control system of claim 1 further comprising a sensor configured to measure speed of the motor and output a signal to the controller, wherein the revolution count is based on the signal.

3. The climate control system of claim 2, wherein the sensor is a hall-effect sensor.

4. The climate control system of claim 1, wherein the revolution count is based on a voltage command for the motor.

5. The climate control system of claim 1, wherein the revolution count is based on a speed of the motor.

6. The climate control system of claim 1, wherein the message is a visual indicator displayed on a display.

7. The climate control system of claim 1, wherein the message is an audio alert.

8. The climate control system of claim 1, wherein the controller is further programmed to issue a message to change the air filter in response to a filter-mileage count exceeding a predefined mileage threshold.

9. A climate control system comprising:
a fluid path;
a blower motor;
a fan fixed to a spindle of the blower motor and disposed in the path;
an air filter disposed in the path; and
a controller programmed to, in response to a revolution count of the motor exceeding a predefined threshold, issue a message to change the air filter.

10. The climate control system of claim 9, wherein the controller is further programmed to, in response to a vehicle travel miles count exceeding a predefined mileage threshold, issue a message to change the air filter.

11. The climate control system of claim 9 further comprising a sensor configured to measure revolutions of the blower motor and output a signal to the controller, wherein the revolution count is based on the signal.

12. The climate control system of claim 9 further comprising a sensor configured to measure speed of the blower motor and output a signal to the controller, wherein the revolution count is based on the signal.

13. The climate control system of claim 12, wherein the sensor is a hall-effect sensor.

14. The climate control system of claim 9, wherein the controller is further programmed to receive a signal indicative of a voltage commanded to the blower motor, wherein the revolution count is based on the signal.

15. The climate control system of claim 14, wherein the controller is further programmed to calculate a speed of the blower motor that corresponds to the voltage commanded, wherein the revolution count is based on the speed of the blower motor.

16. A method of monitoring a cabin air filter of a climate system, comprising:
by a controller,
operating a blower motor that drives a fan configured to circulate an airstream through the cabin air filter, and
issuing a message to change the cabin air filter in response to counted revolutions of the blower motor exceeding a predefined threshold.

17. The method of claim 16 further comprising:
issuing a message to change the cabin air filter in response to counted travel miles of a vehicle exceeding a predefined mileage threshold.

18. The method of claim 16, wherein the counted revolutions are based on a signal from a sensor.

19. The method of claim 16, wherein the counted revolutions are based on a voltage command for the blower motor.

20. The method of claim 16, wherein the message is a visual indicator displayed on a display.
